(19) United States
(12) Patent Application Publication
(10) Pub. No.: US 2005/0172096 A1
(43) Pub. Date: Aug. 4, 2005

(54) Morphing memory pools

(75) Inventors: Hendrikus Christianus Wilhelmus Van Heesch, Eindhoven (NL); Egidius Gerardus Petrus Van Doren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/509,456

(22) PCT Filed: Mar. 14, 2003
(86) PCT No.: PCT/IB03/01008

(30) Foreign Application Priority Data
Apr. 3, 2002 (EP) 02076271.2

(51) Int. Cl. G06F 12/00

(52) U.S. Cl. 711/170

(57) ABSTRACT

The invention relates to a method, the use of such a method and an integrated circuit for altering memory configurations in a physical memory. A memory configuration comprising memory pools of memory packets can be changed into a new memory configuration by detecting a released memory packet within a memory pool of said first memory configuration, assigning memory from said released memory packet to said second memory configuration, determining the size of said assigned free memory of said second memory configuration and allocating within said assigned free memory a required amount of memory for a memory packet of a pool of said second memory configuration in case that assigned free memory size satisfies that allocation request. By said transition a seamless mode change may be applied and memory packets released within a first mode may already be used by said second mode. Fragmentation may be avoided.

The invention relates to a method for altering memory configurations in a physical memory where a first memory configuration and at least a second memory configuration are defined by at least one memory pool comprising at least one memory packet, respectively. The invention further relates to the use of such a method.

In many applications physical memory is limited and must be used efficient. To use the physical memory, an allocator has to allocate free memory blocks within the provided physical memory. As memory blocks are allocated and deallocated within time, the physical memory gets fragmented, which means that blocks of not allocated memory between allocated blocks of allocated memory occur. These so called holes cause that not all available physical memory can be used by the application.

From “Dynamic Storage Allocation: A Survey and Critical Review”, Paul R. Wilson, et al., Dep. of Computer Sciences, University of Texas at Austin, allocators, and mechanisms for avoiding fragmentation in memories, are known. Allocators are categorised by the mechanism they use for recording which areas of memory are free and for merging adjacent free blocks into lager free blocks. Important for an allocator is its policy and strategy, i.e. whether the allocator properly exploits the regularities in real request streams.

An allocator provides the functions of allocating new blocks of memory and releasing a given block of memory. Different applications require different strategies of allocation, as well as different memory sizes. A strategy for allocation is to use pools of equally sized memory blocks. These equally sized memory blocks may also be called packets. Each allocation request is mapped onto a request for a packet from a pool that satisfies the request. In case packets are allocated and released within a pool, external fragmentation is avoided. Fragmentation within a pool may only occur in case a requested memory block does not fit exactly into a packet of the selected pool.

In streaming systems, the streaming data is processed by a graph of processing nodes. The processing nodes process the data, using data packets. Each packet corresponds to a memory block in a memory, which is shared by all processing nodes. A streaming graph is created when it is known which processing steps have to be carried out on the streaming data. The size of the packets within the pools depend on the data to be streamed. Audio data requires packet sizes of some kilobytes, and video data requires packet sizes of up to one megabyte.

In case a streaming graph has to be changed, the configuration of memory pools has also to be changed. A streaming graph might be changed in case different applications and their data streams are supported within one system. Also the processing steps of a data stream might be changed, which requires to include or remove processing nodes from the streaming graph. As most systems are memory constraint, not all application data may be stored at one time within the memory. That means that memory pools needed for a first application have to be released for memory pools of a second application. By releasing and allocating memory, fragmentation of that memory may occur.

In case a user decides that a certain audio- or a video-filter needs to be inserted, or removed from the streaming graph, the configuration of the memory has to be changed. This configuration change has to be carried out without loosing data. In particular in streaming systems, data keeps on streaming into the system at a fixed rate. It is not possible to stop processing the data by the nodes, wait until one pool is completely released and finally allocate its memory to a new pool. Such a procedure would require buffering of the streaming data, which is not possible with limited memory.

Software streaming is based on a graph of processing nodes where the communication between the nodes is done using memory packets. Each memory packet corresponds to a memory block in a memory, shared by all nodes. Fixed size memory pools are provided in streaming systems. In these memory pools fixed size memory packets are allocated. Each processing node may have different requirements for its packets, so there are typically multiple different pools. A change in the streaming graph, which means that the processing of data is changed, requires a change of memory configuration, because different packet sizes might be required in new memory pools. To allow a seamless change between memory configurations the usage of released memory packets for a new memory pools has to be allowed, prior to the release of all memory packets of a previous memory pool.

As current allocators do not provide a sufficient method for such a seamless change between processing modes, it is an object of the invention to limit the amount of extra buffering while changing the mode of operation. It is a further object of the invention to allow shifting of the same piece of memory between at least two pools in different modes. It is yet a further object of the invention to reuse the same memory by different memory pools in different modes.

These objects of the invention are solved by a method comprising the steps of detecting a released memory packed within a memory pool of said first memory configuration, assigning memory from said released memory packed to said second memory configuration, determining the size of said assigned free memory of said second memory configuration, and allocating within said assigned free memory a required amount of memory for a memory packet of a pool of said second memory configuration in case said assigned free memory size satisfies said allocation request.

The advantages are that transitions between operation modes are seamless and no extra hardware and only a little extra memory is required. Memory fragmentation only occurs during transition between different modes.

A memory configuration provides a defined number of memory pools, each comprising a certain number of memory packets, whereby a memory pool is made up by at least one memory packet.

When a processing node has processed a data packet, the memory of this data packet may be released, as the processed data is sent to the next processing node. Which means that the allocator releases a memory packets after processing of the stored data.

In case a memory packet within a first memory configuration is released, this memory packet can be assigned to a second memory configuration. It is also possible that a transition to a further memory configuration may be carried out.

After assigning free memory to at least said second memory configuration the overall size of this assigned free memory is determined. This is the size of all released memory packets from said first memory configuration, which are assigned to at least said second memory configuration, and which are not reallocated, yet.

In case the size of the assigned free memory satisfies a memory request for a memory packet for a pool of said second memory configuration, this memory packet is allocated within said assigned free memory. That means that released free memory may be used by a second memory configuration prior to the release of all allocated memory packets of said first memory configuration.

To apply configuration changes between more than two memory configurations, a method according to claim 2 is preferred. In that case, a transition to a further memory configuration may be carried out, even though previous transition is not wholly completed.

To assure that all memory packets of a first configuration are released and assigned to a second configuration, a method according to claim 3 is preferred.

In some cases not all memory is used by a memory configuration. Thus, a method according to claim 4 is preferred. In that case free memory may be allocated to memory packets of said second memory configuration ahead of releasing any memory packets of said first memory configuration. It is also possible that memory is assigned to memory packets of more than one following memory configuration.

To allow allocation of memory packets a method according to claim 5 is preferred. In that case, memory configurations are fixed in advance for all configurations.

When streaming data is processed, equally sized memory packets according to claim 6 are preferred.

To assure a mode change within a certain time, releasing memory packets according to claim 7 is preferred.

To allow an efficient allocation of memory pools and memory packets in case a memory configuration is changed, a method according to claim 8 is preferred. Previous to changing from a first configuration to a second configuration, the allocator knows the second configuration, which means that the allocator knows the number of memory pools and the sizes of memory packets within said pools.

The use of a previously described method in streaming systems, in particular in video- and audio-streaming systems, where a memory configuration is based on a defined streaming graph, is a further aspect of the invention.

An integrated circuit, in particular a digital signal processor, a digital video processor, or a digital audio processor, providing a memory allocation according to previously described method is yet another aspect of the invention.

These and other aspects of the invention will be appeared from, and elucidated with reference to the embodiments described hereinafter.

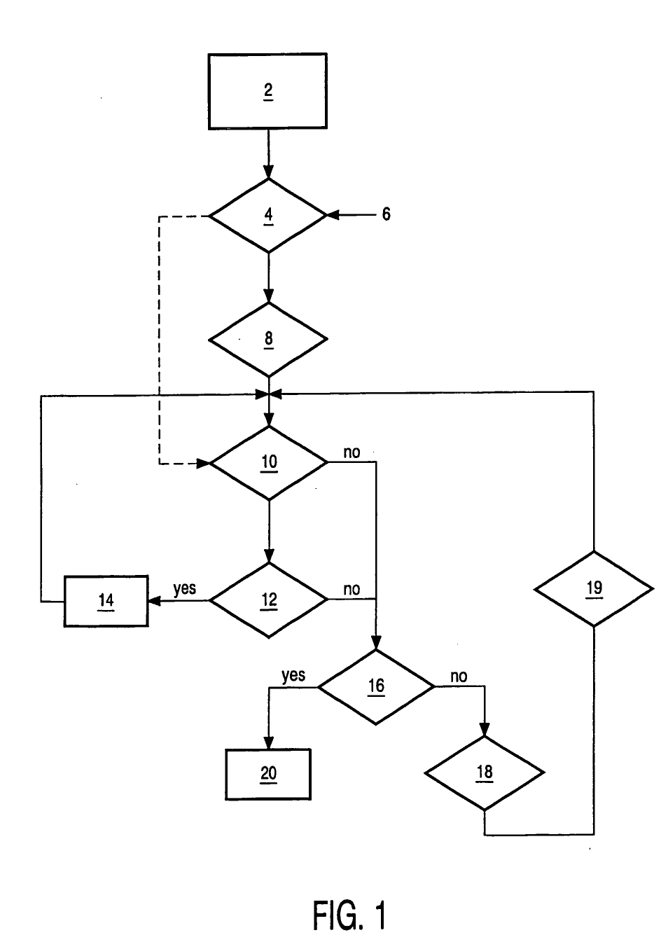

FIG. 1 a flowchart for an inventive method;

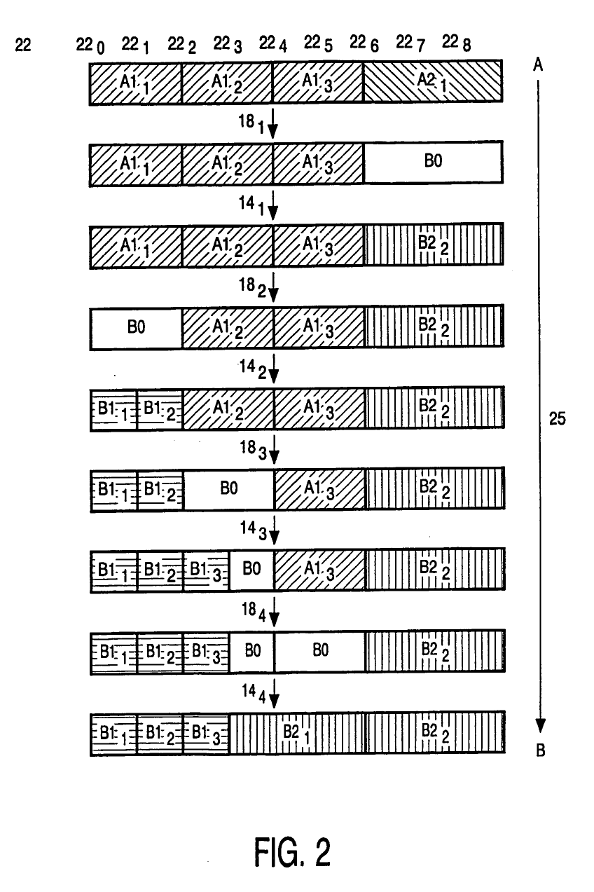

FIG. 2 a diagrammatic view of a memory configuration.

FIG. 1 depicts a flowchart of a method according to the invention. In step 2 a configuration A is defined and allocated within a memory. Configuration A describes the number of memory pools and the number and size of memory blocks (packets) within each of said memory pools.

In case a mode change is requested 6 a new memory configuration B has to be determined 4. The memory configuration B is determined based on the needs of the requested mode.

In step 8 all free memory of configuration A is assigned to configuration B. In step 10 it is determined whether any memory requests are still pending. These requests are determined based on the memory configuration B, which has been determined previously in step 4. The allocator knows whether memory packets still have to be allocated to configure the memory according to configuration B or not.

In case there are pending memory requests, it is determined whether the assigned free memory for configuration B is large enough for a memory packet of configuration B in step 12. In case the free memory assigned to configuration B is large enough for a memory packet of a pool of configuration B, this memory packet is allocated within the free assigned memory in step 14.

In case the size of the assigned free memory is smaller than any requested memory packet of any pool of configuration B step 16 is processed. It is determined whether still any packets are allocated for configuration A in step 16. In case there are still any memory packets allocated for configuration A, a release of any memory packets within configuration A is awaited in step 18.

After a memory packet within configuration A is released, the released memory packed is assigned to configuration B in step 19. The steps 10, 12, 14, 16, 18 and 19 are processed until no more memory requests are pending.

If is detected in step 10 that configuration B is wholly configured and no more memory requests are pending, the steps 10, 16, 18, 19 are processed until all memory packets of configuration A are released. If this is the case the mode transition is ended in step 20. After all steps 2 to 20 are processed, the memory is configured according to configuration B and no further memory packets are allocated for configuration A.

During transition from configuration A to configuration B, memory packets may be used in configuration B before all memory packets of configuration A are released.

In FIG. 2 a diagrammatic view of a memory configuration is depicted. The memory 22 is addressable via memory addresses 22₀-22₈. In configuration A, memory 22 is divided in two pools A1, A2, pool A1 comprising three packets of size 2, and pool A2 one packet of size 3. During transition 25 from configuration A to configuration B, the memory 22 will be reorganised into two pools B1, B2, pool B1 comprising three packets of size 1, and pool B2 two packets of size 3.

In step 18₁ packet A2₁ at address 22₆ is released and the released memory is assigned to configuration B0. In step 14₁ the assigned free memory B0 is allocated to memory packet B2₂. In step 18₂ memory packet A1₁ at address 22₀ is released and assigned to free memory B0. In step 14₂ memory packets B1₁, B1₂ are allocated at memory addresses 22₀, 22₁ within free memory B0. In step 18₃ memory packet A1₂ is released at memory address 22₂ and in step 14₃ memory packet B1₃ is allocated within free memory B0. In step 18₄, memory packet A1₃ is released and assigned to free memory B0. Finally in step 14₄ memory packet B2₁ is allocated within free memory B0 at address 22₃.

By applying the inventive method, a pool is placed in both configurations at a same memory position and the amount of packets that can be added to pools of new configurations can be maximised when a packet from a previous configuration is released.

By using the extra knowledge where a packet will need to be allocated in a future mode, fragmentation may be prevented. Furthermore, memory pools can be allocated incrementally, which reduces the latency of a streaming system and thus the amount of memory that is required for seamless modes changes.

1. Method for altering memory configurations in a physical memory where a first memory configuration and at least a second memory configuration are defined by at least one memory pool comprising at least one memory packet, respectively, comprising the steps of:
a) detecting a released memory packet within a memory pool of said first memory configuration,
b) assigning memory from said released memory packet to said second memory configuration,
c) determining the size of said assigned free memory of said second memory configuration, and
d) allocating within said assigned free memory a required amount of memory for a memory packet of a pool of said second memory configuration in case said assigned free memory size satisfies said allocation request.

2. Method according to claim 1, characterized by repeating the steps a-d until all allocated memory packets of said first memory configuration are released and all memory packets of said second memory configuration are allocated.

3. Method according to claim 1, characterized by carrying out an alteration of said memory configurations according to steps a-d to a further memory configuration prior to the release of all memory packets of said previous memory configurations.

4. Method according to claim 1, characterized by assigning all free memory of said first memory configuration to at least said second memory configuration prior to step a.

5. Method according to claim 1, characterized by configuring said memory configurations by allocating a fixed memory location to said at least one memory pool, and assigning memory packets within each of said at least two memory pools.

6. Method according to claim 1, characterized by allocating equally sized memory packets within a memory pool.

7. Method according to claim 1, characterized by releasing memory packets of said first memory configuration within a finite time.

8. Method according to claim 1, characterized by determining said second configuration prior to step a.

9. Use of a method according to claim 1 in streaming systems, in particular in video- and audio-streaming systems, where a memory configuration is based on a defined streaming graph.

10. Integrated circuit, in particular a digital signal processor, a digital video processor, or a digital audio processor, providing a memory allocation method according to claim 1.
